(19) United States
(12) Patent Application Publication
(10) Pub. No.: US 2001/0008001 A1
(43) Pub. Date: Jul. 12, 2001

(54) Switching system and scramble control method

(75) Inventor: Yoshihiko Suemura, Tokyo (JP)

Correspondence Address: FOLEY & LARDNER, Washington Harbour, 3000 K Street, N.W., Suite 500, P.O. Box 25696, Washington, DC, 20007-8696, US

(73) Assignee: NEC CORPORATION.

(21) Appl. No.: 09/742,236

(22) Filed: Dec. 22, 2000

(30) Foreign Application Priority Data
Dec. 24, 1999 (JP) 367830/1999

(51) Int. Cl. G06F 13/38; H04J 3/06

(52) U.S. Cl. 710/129; 714/781; 370/515

(57) ABSTRACT

A scramble control method allowing synchronization of scramblers and descramblers without resetting them per frame is disclosed. The scramblers are simultaneously reset and the descramblers are simultaneously reset. The scramblers are simultaneously initialized at a first time point and thereafter tire not reset. The descramblers are simultaneously initialized after an elapse of a time period required for transferring a frame from an input interface to an appropriate output interface through the switch, and thereafter the descrambler are not reset. Alternatively, a scrambler state indicating a pseudorandom pattern is generated at predetermined intervals and is sent to the scramblers and the descrambler.

### BACKGROUND OF THE INVENTION

1. Field of the Invention

The present invention relates to a switching system in a communication network, and more particularly relates to a scramble system for a signal forwarded in the switching system.

2. Description of Related Art

In general, a communication network Includes a plurality of nodes and transmission devices for transmitting signals between nodes, wherein each node includes a switching system for switching signals. Most transmission devices have adopted an optical transmission system. In the field of switching systems, research and development on optical switching systems have been widely conducted.

In general, a switching system is composed of a switch for switching signals, an input interface connected to each input port of the switch, an output interface connected to each output port of the switch, and a controller controlling the above components. At the input interface and the output interface, signal processing including buffering, coding and decoding is performed. In the optical switching system, this signal processing can be optically performed in principle. However, the current optical signal processing technique is sufficiently immature and therefore an input signal is once converted into an electric signal and the signal processing is electrically performed.

In such an optical switching system, each input interface is provided with an optical transmitter for transmitting an optical signal to a corresponding input port of the optical switch, and each output interface is provided with an optical receiver for receiving an optical signal from a corresponding output port of the optical switch. A bit rate of an optical signal in an optical switching system is generally not less than 1 Gb/s, and an optical receiver which receives optical signals with such a high bit rate mostly uses AC-coupled electric circuits. For this reason, it is necessary to set a mark rate of an optical signal to about 0.5 on average. Moreover, the optical receiver extracts a clock from an optical signal so as to operate in slave synchronization with the input interface. However, in order to stably extract a clock, it is necessary that transition of an optical signal between 0 and 1 is made at sufficiently high frequency.

Due to the above two reasons, in the optical switching system, transmission line encoding is mostly performed on an optical signal by any method. As an example of such an optical switching system, an optical packet switching system having an exchange capacity of 2.56 Tb/s has been disclosed in Technical Report of IEICE OCS 99-23 (1996-6), pp. 15-20 (Suemura and the others).

This optical packet switching system is composed of at least one buffer memory and input interface, one optical switch, at least one output interface and elastic memory, and one arbiter. Each frame of an switched signal is composed of a preamble, a frame synchronization pattern, a payload, and a CRC.

As for an electrical signal packet input into the buffer memory, after conflict of forwarding destinations is arbitrated, the packet is stored in the payload of a frame to produce a frame and the frame is converted into an optical signal to be input into the optical switch. The optical switch performs switching per frame under control of the arbiter. The output interface converts the received optical signal into an electric signal and extracts the original packet from the frame.

Here, the input interface operates in synchronization with a system clock distributed to the whole system, but the output interface operates in synchronization with a clock extracted from the optical signal. Therefore, the output interface obtains a clock which is delayed from the system clock by an amount corresponding to a path length from the input interface to the output interface, and its phase is not always equal to the phase of the system clock. Therefore, the elastic memory is used to change from the clock of the output interface to the system clock.

In addition, In the optical switching system, an optical signal is in off state momentarily when the optical switch performs switching, and a bit of that portion may be lost. Therefore, a constant time which is called as a guard time is generally provided at a boundary of frames, and the optical switch performs switching at the guard time. An example of such an optical switching system has been disclosed in Japanese Patent Application Unexamined Publication No. 60-137198 (1985).

In addition, the transmission source of a frame received by the output interface changes every time when the optical switch performs switching, and path lengths from the respective input interfaces to the optical switch are not completely equal to each other. For this reason, every time when the optical switch performs switching, the bit phase and frame phase of a frame received by the output interface possibly change. For this reason, it is necessary to retake bit synchronization and frame synchronization per frame at the output interface. Since there is a strong possibility that an error is mixed in bit received until bit synchronization is taken, it is necessary to add a bit synchronization pattern to the head of a frame. The preamble serves both as guard time and bit synchronization pattern. Frame synchronization is achieved by retrieving frame synchronization pattern.

The CRC is calculated as cyclic redundancy check code for the payload in the input interface and the same calculation is made also in the output interface. The calculated results are compared with CRC so that an error of the payload can be detected.

Payload and CRC of these areas are scrambled and undergo 16BIC coding as transmission line coding.

Scramble generally prevents tapping. When a constant signal pattern continues, received clocks become unstable, cross talk, a noise and the like occur. Therefore, in order to prevent them, in scramble at the input interface, data are processed according to a predetermined rule and a change in phase is randomized. Scramble is performed by calculating exclusive OR of a pseudo-random pattern generated by a generator polynomial (for example, 1+X⁶+X⁷) and a combination of payload and CRC. The scramble is reset at the head of the payload. This scramble randomizes bit strings of the payload and CRC.

The 16BIC coding is performed by inserting an inverted bit as the sixteenth bit into each 16 bits in a encoder of the input interface. As a result, a length of the consecutive same codes of the payload and CRC is limited to a maximum of 17 bits In the output interface, 16BIC code is decoded and descrambled. Namely, the last 1 bit is deleted from each 17 bits of the payload and CRC, and an exclusive OR of the 16BIC code and the pseudo-random pattern generated by 1+X⁶+X⁷ is calculated. These processes are performed after frame synchronization, and a descrambler is reset at the head of the payload. For this reason, the payload and CRC after decoding and descramble at the output interface become equal to payload and CRC before coding and scramble at the input interface.

In such a manner, scrambler and descrambler are reset in a specified position of a frame, and synchronization of the scrambler and descramble is realized by frame synchronization Such a system is called as a frame synchronizing (frame-sync) scramble.

In the case where the frame synchronizing scramble is adopted, a bit string to be used for scramble is fixed to the length of a frame. Namely, all frames are scrambled by the same bit string. Moreover, in the case where a pseudo-random pattern, in which the order of the generator polynomial are comparatively low, namely, a pattern length is short, is used for scramble, the bit string to be used for scramble is a repeating pattern of comparatively short cycle. A communication system adopting such a scramble system can easily predict a string bit which is obtained by converting a bit string transmitted from a client after scramble. As a result, this communication system is easily attacked by a third party who bears ill will.

Such a problem has been described in James Manchester et al., “IP over SONET”, IEEE (Communication Magazine, May 1998, pp. 136-142. This document indicates a problem of IP over SONET system for transmitting IP packet being stored in a frame of SONET. SONET adopts frame synchronizing scramble using 1+X⁶+X⁷. Originally, SONET is designed on condition that a byte-multiplied signal would be transmitted. In a byte-multiplied signal, a bit string transmitted from one client does not extend over continuous plural bytes. However, in the IP over SONET system, an IP packet is not byte-multiplied and stored in a frame of SONET.

For this reason, there are cases where a bit string transmitted from one client is over consecutive plural bytes in a SONET frame. If this bit string is identical to a bit string to be used in a scrambler, the bit string is scrambled to be converted into consecutive 0s. Continuation of same codes over plural bytes interferes with extraction of a clock in the optical receiver or causes a bit error. A third party who bears ill will easily makes such an attack on purpose.

The generator polynomial 1+X⁶+X⁷ for forming a pseudo-random pattern is adopted in the SONET scramble system and its length is 127 bits. Therefore, even if a client does not know a position of a SONET frame where an IP packet transmitted by the client is located, a pseudo-random pattern where the generator polynomial is 1+X⁶+X⁷ is continued to be transmitted using an IP packet, the pattern synchronizes with a scrambler of SONET with probability of 1/127, allowing the same code to be generated continuously.

A similar problem arises also in the above-mentioned optical switching system devised by Suemura. Since the optical switching system devised by Suemura adopts a transmission line coding system in which scramble and 16BIC code arc combined, the same codes of not less than 17 bits are not generated continuously. However, a mark factor becomes 1/17 or 16/17 in the worst case, and extraction of a clock at the optical receiver becomes unstable and bit errors possibly occur.

As a means for solving such a problem, Manchester et al. have proposed a system which uses both the conventional SONET scramble and self-synchronizing scramble utilizing a pseudo-random pattern generated by the generator polynomial: 1+X⁴³. A length of a pseudo-random pattern generated by 1+ X⁴³ is 8,796,093,022,207 (=2⁴³−1) bits. A self-synchronizing scrambler is not reset in a specified position of a frame and performs scramble continuously over plural frames. Descramblers require at least 43 bits for synchronization, but can maintain synchronization by performing descramble continuously over plural frame when they once synchronize with each other similarly to the scrambler. In this system, the probability that a bit string transmitted from a third party synchronizes with two scramblers is 9×10⁻¹⁶, and this can be almost ignored.

However, this system cannot be applied directly to an optical switching system. In self-synchronizing scramble, internal states of a scrambler and a descrambler, namely, the value of a bit string stored in a register varies with bit strings of the past. As mentioned before, in the optical switching system, a transmission source of a frame received by the output interface varies every time when the optical switch performs switching. For this reason, synchronization between the scrambler and the descrambler is lost when switching is performed. Moreover, even if the frame synchronizing scrambler is used, in the case where the scrambler and the descrambler are not reset per frame to be operated continuously, it is not secured that the scramblers of all the input interfaces operate synchronously with each other. For this reason, the synchronization between the scrambler and descrambler is possibly lost each time when the optical switch performs switching.

This is a problem peculiar to a switching system, and this problem cannot be solved by synchronizing systems devised for a one-to-one transmission device including the above-mentioned system devised by Manchester et al.

Moreover, this problem is peculiar not only to an optical switching system but also to a switching system adopting an electric system in which scramble is applied to a signal in the system.

### SUMMARY OF THE INVENTION

It is an object of the present Invention to provide a scramble control method and a switching system allowing synchronization of scramblers and descramblers without resetting them per frame in the case where scramble is applied to an internal signal of the switching system.

A scramble control method according to the present invention is used in a switching system including: a switch; a plurality of input interfaces each connected to input ports of the switch, each of the input interfaces including a scrambler using a predetermined pseudorandom pattern generator, wherein each of the input interfaces inputs data to sequentially output frames including scrambled data to a corresponding input port of the switch; and a plurality of output interfaces each connected to output ports of the switch, each of the output interfaces including a descrambler using the predetermined pseudorandom pattern generator, wherein each of the output interfaces inputs frames including scrambled data from a corresponding output port of the switch to output frames of original data. The scramble control method includes the steps of: resetting the scramblers simultaneously; and resetting the descramblers simultaneously.

According to an aspect of the present invention, the scramblers and the descramblers operate according to a predetermined system clock, wherein the scramblers are simultaneously initialized at a first time point and thereafter are not reset, and the descramblers are simultaneously initialized at a second time point and thereafter are not reset, wherein the second time point is delayed from the first time point by a time period required for transferring a frame from an input interface to an appropriate output interface through the switch.

According to another aspect of the present invention, the scramble control method further includes the steps of: generating a scrambler state indicating a pseudorandom pattern generated by the predetermined pseudorandom pattern generator at predetermined intervals; sending the scrambler state to the scramblers so that the scramblers are simultaneously reset to the pseudorandom pattern indicated by the scrambler state; and sending the scrambler state to the descramblers with a delay of a time period required for transferring a frame from an input interface to an appropriate output interface through the switch, so that the descramblers are simultaneously reset to the pseudorandom pattern indicated by the scrambler state.

According to still another aspect of the present invention, each of the scramblers generates a scrambler state Indicating a pseudorandom pattern generated by the predetermined pseudorandom pattern generator in frame timing; assembles a frame including the scrambler state; and transfers the frame including the scrambler state to the switch. Each of the descramblers receives a frame including a scrambler state; and resetting the predetermined pseudorandom pattern generator to the pseudorandom pattern indicated by the scrambler state.

A switching system according to the present invention, includes: a switch; a plurality of input interfaces each connected to input ports of the switch, each of the input interfaces including a scrambler using a predetermined pseudorandom pattern generator, wherein each of the input interfaces inputs data to sequentially output frames including scrambled data to a corresponding input port of the switch; a plurality of output interfaces each connected to output ports of the switch, each of the output interfaces including a descrambler using the predetermined pseudorandom pattern generator, wherein each of the output interfaces inputs frames including scrambled data from a corresponding output port of the switch to output frames of original data; and a reset pulse generator for generating a scrambler reset pulse and a descrambler reset pulse, wherein the scrambler reset pulse is sent to all the scramblers at equal timing, and the descrambler reset pulse is sent to all the descramblers at equal timing.

The scramblers and the descramblers may operate according to a predetermined system clock, wherein the scramblers are initialized in response to the scrambler reset pulse and thereafter are not reset, and the descramblers are initialized in response to the descrambler reset pulse and thereafter are not reset, wherein the descrambler reset pulse is delayed from the scrambler reset pulse by a time period required for transferring a frame from an input interface to an appropriate output interface through the switch.

A switching system according to the present invention, includes: a switch; a plurality of input interfaces each connected to input ports of the switch, each of the input interfaces including a scrambler using a predetermined pseudorandom pattern generator, wherein each of the input interfaces inputs data to sequentially output frames including scrambled data to a corresponding input port of the switch; a plurality of output interfaces each connected to output ports of the switch, each of the output interfaces including a descrambler using the predetermined pseudorandom pattern generator, wherein each of the output interfaces inputs frames including scrambled data from a corresponding output port of the switch to output frames of original data; and a scramble state generator for generating a scrambler state indicating a pseudorandom pattern generated by the predetermined pseudorandom pattern generator at predetermined intervals, wherein the scrambler state is sent to the scramblers so that the scramblers are simultaneously reset to the pseudorandom pattern indicated by the scrambler state, and the scrambler state is sent to the descramblers with a delay of a time period required for transferring a frame from an input interface to an appropriate output interface through the switch, so that the descramblers are simultaneously reset to the pseudorandom pattern indicated by the scrambler state.

A switching system according to the present invention, includes: a switch; a plurality of input interfaces each connected to input ports of the switch, each of the input interfaces including a scrambler using a predetermined pseudorandom pattern generator, wherein each of the input interfaces inputs data to sequentially output frames including scrambled data to a corresponding input port of the switch; and a plurality of output interfaces each connected to output ports of the switch, each of the output interfaces including a descrambler using the predetermined pseudorandom pattern generator, wherein each of the output interfaces inputs frames including scrambled data from a corresponding output port of the switch to output frames of original data, wherein each of the scramblers further comprises: a scramble state generator for generating a scrambler state indicating a pseudorandom pattern generated by the predetermined pseudorandom pattern generator in frame timing; and an assembler for assembling a frame including the scrambler state, and each of the descramblers further comprises: a reset circuit for resetting the predetermined pseudorandom pattern generator to the pseudorandom pattern indicated by a scrambler state included in a frame received from the switch.

### BRIEF DESCRIPTION OF THE DRAWINGS

FIG. 1 is a structural diagram of a first embodiment of the present invention;

FIG. 2 is a diagram showing a frame structure of the first embodiment;

FIG. 3 is a structural diagram of an input interface according to the first embodiment;

FIG. 4 is a timing chart showing an operation of an input interface (as indicated by A to E) and an operation of an output interface (as indicated by F to J) according to the first embodiment, wherein the respective symbols A, B, C, D and E of FIG. 4 represent combinations of data and frame pulse at points A, B, C, D and E of FIG. 3 and the respective symbols F, G, H, I and J of FIG. 4 represent combinations of data and frame pulse at points F, G, H, I and J of FIG. 6;

FIG. 5 is a structural diagram of a scrambler according to the first embodiment;

FIG. 6 is a structural diagram of the output interface according to the first embodiment;

FIG. 7 is a structural diagram of a descrambler according to the first embodiment;

FIG. 8 is a structural diagram of a second embodiment of the present invention;

FIG. 9 is a structural diagram of a scrambler state generator according to the second embodiment;

FIG. 10 is a timing chart showing an operation of the scrambler state generator according to the second embodiment;

FIG. 11 is a structural diagram of the input interface according to the second embodiment;

FIG. 12 is a structural diagram of the scrambler according to the second embodiment;

FIG. 13 is a timing chart showing an operation of the scrambler according to the second embodiment;

FIG. 14 is a structural diagram of the output interface according to the second embodiment;

FIG. 15 is a structural diagram of the descrambler according to the second embodiment;

FIG. 16 is a structural diagram of a third embodiment of the present invention;

FIG. 17 is a diagram showing a frame structure of the third embodiment;

FIG. 18 is a structural diagram of the input interface according to the third embodiment;

FIG. 19 is a timing chart showing an operation of the input interface according to the third embodiment;

FIG. 20 is a structural diagram of the scrambler according to the third embodiment;

FIG. 21 is a timing chart showing an operation of the scrambler according to the embodiment;

FIG. 22 is a structural diagram of the output interface according to the third embodiment;

FIG. 23 is a timing chart showing an operation of the output interface according to the third embodiment;

FIG. 24 is a structural diagram of the scrambler according to the third embodiment; and

FIG. 25 is a timing chart showing an operation of the descrambler according to the third embodiment.

### DESCRIPTION OF THE PREFERRED EMBODIMENTS

### First Embodiment

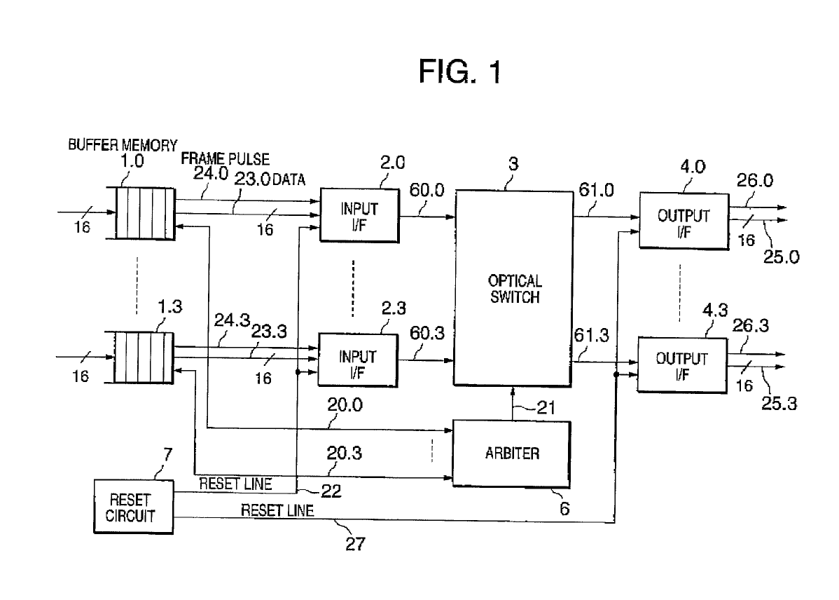

Referring to FIG. 1, a 4×4 optical packet switching system according to a first embodiment of the present invention includes a plurality of buffer memories 1 (here, indicated by reference numerals 1.0 through 1.3 and so on), input interfaces 2 (2.0 through 2.3), an optical switch 3, output interfaces 4 (4.0 through 4.3), an arbiter 6, and a reset circuit 7.

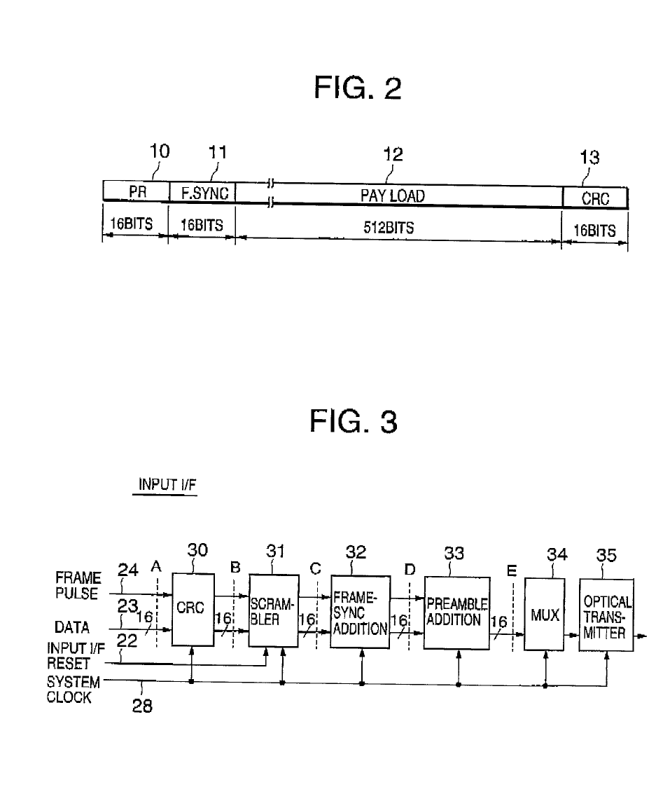

In addition, as shown in FIG. 2, a frame is composed of a 16-bit preamble 10, a 16-bit frame synchronization pattern 11, a 512-bit payload 12, and a 16-bit cyclic redundancy check code CRC 13.

In FIG. 1, a system clock is supplied by a clock source (not shown) to the buffer memories 1, the input interfaces 2, the output interfaces 4, the arbiter 6, and the reset circuit 7. When electrical packet signals input to the optical packet switching system, they are stored in corresponding ones of the butter memories 1 (1.0 through 1.3).

The respective buffer memories 1 output the forwarding destinations of the incoming packets to the arbiter 6 via arbitration lines 20 (20.0 through 20.3). If the forwarding destinations conflict, then the arbiter 6 arbitrates the forwarding destinations. The transmission timing of each packet determined by the arbitration is returned to the buffer memories 1 via the arbitration lines 20. Each of the incoming packets output from respective ones of the buffer memories 1 is written into the payload 12 of a frame as shown in FIG. 2 and the frames are converted into optical signals at respective ones of the input interfaces 2 (2.0 through 2.3). The optical signals are input into the optical switch 3 via optical fibers 60 (60.0 through 60.3), respectively.

The optical switch 3 is a 4×4 optical crossbar switch, which switches each frame under control of the arbiter 6. The switching operation by the optical switch 3 is performed within the time while the preamble 10 of the frame passes through tho optical switch 3. The optical signals output from the optical switch 3 are input into the output interfaces 4 (4.0 through 4.3) via optical fibers 61 (61.0 through 61.3), respectively. The respective output interfaces 4 convert the received optical signals into electric signals and extract the original packets from the frames.

Input Interface

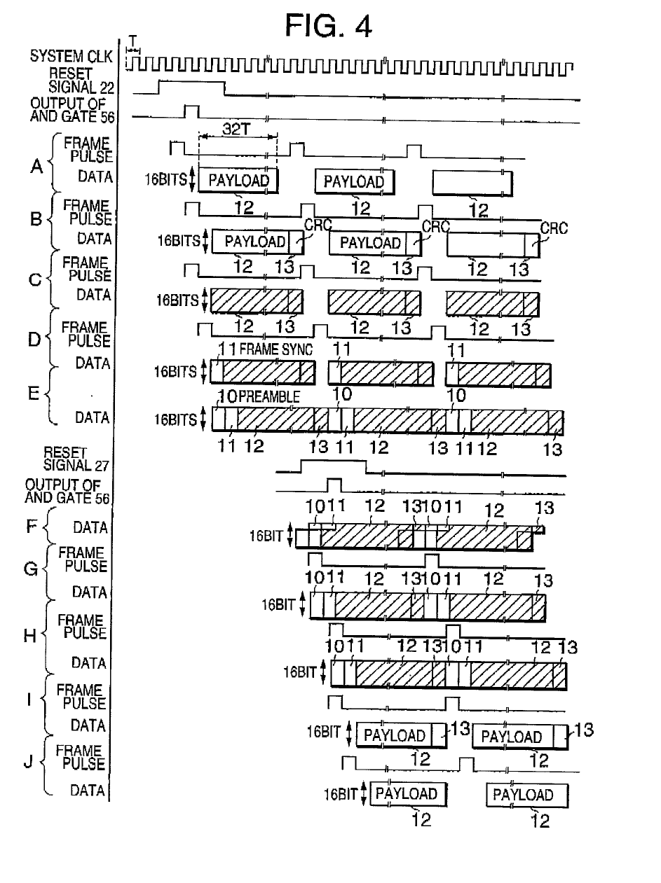

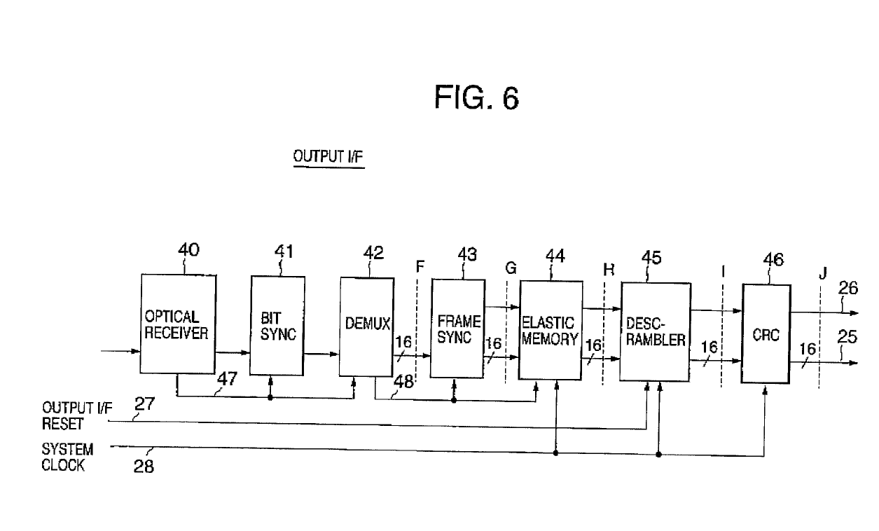

FIG. 3 shows an input interface, and FIG. 4 shows an operation of the input interface (as Indicated by A to E) and an operation of the output interface (as indicated by F to J). The respective symbols A, B, C, D and E of FIG. 4 represent combinations of data and frame pulse at points A, B, C, D and E of FIG. 3. As described later, the respective symbols F, G, H, I and J of FIG. 4 represent combinations of data and frame pulse at points F, G, H, I and J of FIG. 6.

As shown in FIG. 3, the input interface 2 is composed of a CRC addition section 30, a scrambler 31, a frame synchronization pattern addition section 32, a preamble addition section 33, a multiplexer 34 and an optical transmitter 35. All the blocks of the input interface 2 operate in synchronization with a system clock of 150 MHz supplied from a clock line 28.

Since a data line 23 is a 16-bit parallel line, 32 clock cycles are needed to input a packet of 64 bytes to the input interface 2. All 0s are inserted into gaps between packets. A packet is stored as it is to the payload 12 of a frame. A frame pulse propagates through a frame pulse line 24 in parallel with the packet. A frame pulse becomes “1” two clock cycle before the head of the payload 12, and becomes “0” in the other cycles.

In the CRC addition section 30, a cyclic redundancy check code of 16 bit is calculated from the payload 12 according to a generator polynomial: 1+X⁵+X¹²+X¹⁶, and the code is added as CRC 13 to the end of the payload 12. The payload 12 and the CRC 13 are scrambled in the scrambler 31. Shaded portions in C, D and E of FIG. 4 indicate scrambled portions.

Scrambler

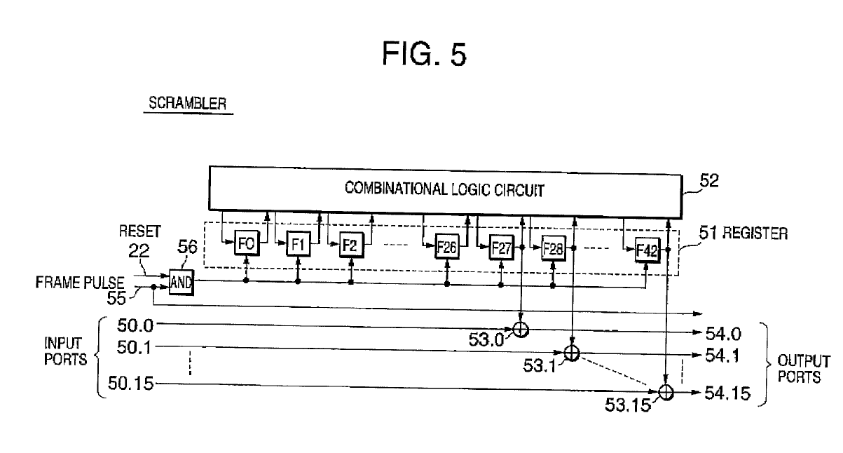

Referring to FIG. 5, the scrambler 31 is composed of sixteen input ports 50 (50.1 through 50.15), a register 51 composed of forty-three flip-flops F0 through F42, a combinational logic circuit 52 for generating a pseudo-random pattern, sixteen XOR circuits 53 (53.0 through 53.15) for calculating exclusive OR of a pseudo-random pattern and input data, sixteen output ports 54 (54.0 through 54.15). and an AND gate 56 for outputting logical AND of a frame pulse on a flame pulse line 55 and a rest signal on a reset line 22.

The scrambler 31 is a 16-bit-parallel frame-synchronizing scrambler using a generator polynomial: 1+X⁴³. Exclusive ORs of the pseudo-random pattern generated at the register 51 and the data input from the input ports 50 are calculated by XOR circuits 53 and the results of the exclusive-OR calculation are output from the output ports 54, respectively. Pseudo-random patterns are generated by feeding back values held in the flip-flops of the register 51 to the register 51 through the combinational logic circuit 52. A detailed method of configuring the combinational logic circuit 52 is described in DooWhan Choi, “Parallel Scrambling Techniques for Digital Multiplexers”, AT&T Technical Journal, Volume 65, Issue 5, pp. 123-136, 1986.

When an output of the AND gate 56 becomes “1” by inputting the frame pulse and the reset signal, all the forty-three flip-flops of the register 51 are reset to “1”. The reset signal of the reset line 22 becomes “1” only when the system is up or when the scrambler 31 or descrambler (described later) is out of synchronization. Therefore, after the scrambler 31 is reset on start-up, the scrambler 31 operates continuously over frames without being reset.

As shown in FIG. 3, the frame synchronization pattern addition section 32 adds a frame synchronization pattern 11 to the payload 12 and the CRC 13 outputted by the scrambler 31 and then the preamble addition section 33 further adds a preamble 10 to the output of the frame synchronization pattern addition section 32, so that a frame is completed.

The 16-bit parallel data framed as described above and outputted from the preamble addition section 33 is converted into a serial signal of a bit rate of 2.4 Gb/s by the multiplexer 34. This serial signal is converted into an optical signal of 2.4 Gb/s by the optical transmitter 35 so as to be transmitted from the input interface 2 to the optical switch 4.

Output Interface

Next, there will be explained below a structure and an operation of the output interface 4.

Referring to FIG. 6, the output interface 4 is composed of an optical receiver 40, a multiphase-clock bit synchronization section 41, a demultiplexer 42, a frame synchronization section 43, an elastic memory 44, a descrambler 45, a CRC (or error detection) section 46, and clock lines 47 and 48. The operation of the output interface 4 is also shown in FIG. 4, and F, G, H, I and J in FIG. 4 represent data and frame pulses at output points F, G, H, I and J of respective sections following the multiplexer 42 in FIG. 6.

A 2.4 Gb/s optical signal input from the optical switch 3 is converted into an electric signal by the optical receiver 40 and the electric signal is output to the bit sync section 41. Moreover, the optical receiver 40 extracts a serial clock of 2.4 GHz from the received optical signal, and this serial clock is given to the bit sync section 41 and the demultiplexer 42 via the clock line 47. The bit sync section 41 is of multlphase clock type and performs bit synchronization, namely, synchronizes the input electric signal with the serial clock. The bit synchronization is performed in the preamble 10 per frame, and fields of the payload 12 and the CRC 13 following the frame synchronization pattern 11 are output from the bit sync section 41 in bit synchronization. Details of the multiphase-clook bit sync section are described in Japanese Patent Application Unexamined Publication No. 7-193562 (1995) and the like.

A serial signal output from the bit sync section 41 is converted from serial to parallel by the demultiplexer 42 to produce 16-bit parallel data. Moreover, the demultiplexer 42 divides the serial clock of 2.4 GHz supplied via the cloak line 47 by 16 so that a parallel clock of 150 MHz is generated. The parallel clock is supplied to the frame sync section 43 and the elastic memory 44 via the clock line 48.

As for the data output from the demultiplexer 42, frame synchronization is not generally taken. Therefore, as shown by F in FIG. 4. the frame synchronization pattern 11 may be located over two parallel clock cycles. When receiving the data from the demultiplexer 42, the frame sync section 43 retrieves the frame synchronization pattern 11 from the data, and bit rotation is performed for each frame so that the retrieved frame synchronization pattern 11 comes to a predetermined position, namely, the frame synchronization pattern 11 falls within one parallel clock cycle. Moreover, a frame pulse which becomes “1” at the head of the frame and becomes “0” at the other portions is generated and output in synchronization with the data which were subject to bit rotation. As a result, the frame synchronization is realized.

The data and frame pulse output from the frame sync section 43 are written in the elastic memory 44 in synchronization with the parallel clock output from the demultiplexer 42. Meanwhile, an output of the elastic memory 44 is read in synchronization with the system clock distributed via the clock line 28. For this reason, the clock of the data and the frame pulse is changed from the parallel clock generated by dividing the serial clock extracted from the optical signal into the system clock. Moreover, the descrambler 45 and the error detection section 46 at the later stage operate in synchronization with the system clock. The data and the frame pulse output from the elastic memory 44 are input into the descrambler 45.

Descrambler

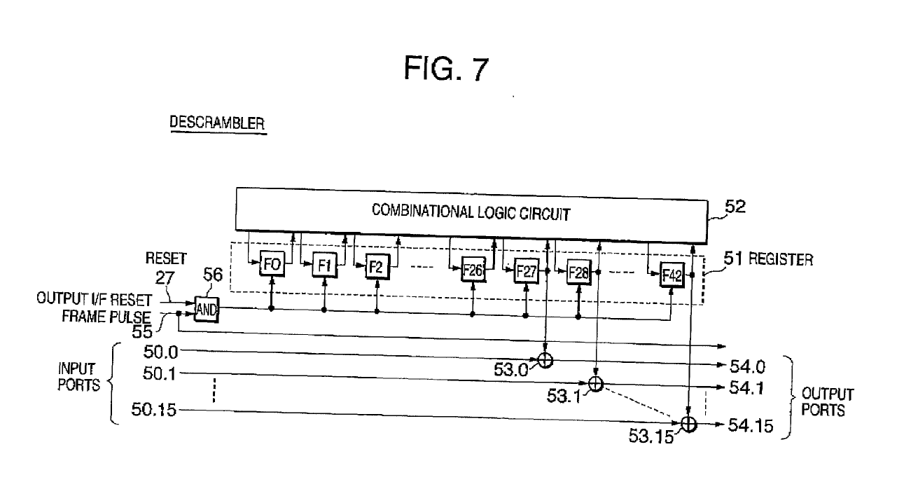

Referring to FIG. 7, the basic circuit configuration of the descrambler 45 is the same as that of the scrambler 31 as shown in FIG. 5 except that the reset line 22 of the scrambler 31 is replaced with a reset line 27 for descrambler. For this reason, the same reference numerals as those of the scrambler 31 are given to blocks which perform the same operations as those of the scrambler 31.

In the register 51 of the descrambler 45, all the flip-flops are reset to “1” when the logical AND of the frame pulse and the reset signal input from the reset circuit 7 via the reset line 27 becomes “1”. The reset signal on the reset line 27 is obtained by delaying the reset signal on the reset line 22 by an amount corresponding to a delay time of data propagating from the scrambler 31 of the input interface 2 to the descrambler 45 of the output interface 4 (here, 37 system clock cycles). Therefore, after the descrambler 45 is reset at the head of the first frame when the system is up, the descrambler 45 is not reset any more. The descrambler 45 operates continuously over frames and its operation completely synchronizes that of the scrambler 31.

In the descrambler 45, the payload 12 and the CRC 13 are descrambled. Actually, the preamble 10 and the frame synchronization pattern 11 are scrambled in the descrambler 45, but since the preamble 10 and the frame synchronization pattern 11 are not required thereafter, they are omitted in FIG. 4.

Data output from the descrambler 45 are input into the error detection section 46. The error detection section 46 calculates a cyclic redundancy check code of 16 bit from the payload 12 using a generator polynomial: 1+X⁵+X¹²+X¹⁶. This code is compared with the CRC 13 of the frame, namely, the cyclic redundancy check code calculated by the CRC addition section 30 of the input interface 2. When they do not match, an alarm is raised. The error detection section 46 simultaneously sets all the preamble 10, the frame synchronization pattern 11 and the CRC 13 to “0” and directly outputs only the payload 12, namely, the packet.

In such a manner, packet switching is performed by the optical packet switching system according to the present embodiment. Scramble for a frame including a packet is performed by using a pseudo-random pattern with sufficiently long cycle of (243−1) bit. Moreover, the scrambler 31 and the descrambler 45 are not reset per frame and operate continuously. Therefore, even if a third party transmits the pseudo-random pattern which is the same as that used for the scrambler 31, there is a very weak possibility 1/(243−1) that this pattern synchronizes with the scrambler 31 and the same code is generated continuously.

In addition, since all the scramblers 31 and descramblers 45 operate synchronously and they are of frame sync type, contents of the register 51 do not depend on data of the past. Therefore, even if switching is performed per frame, the synchronization between the scramblers 31 and the descramblers 45 is maintained.

### SECOND EMBODIMENT

A second embodiment of the present invention is an optical packet switching system in which only the synchronization system of scrambler and descrambler is different from that of the first embodiment. Therefore, only the synchronization system thereof will be described hereafter.

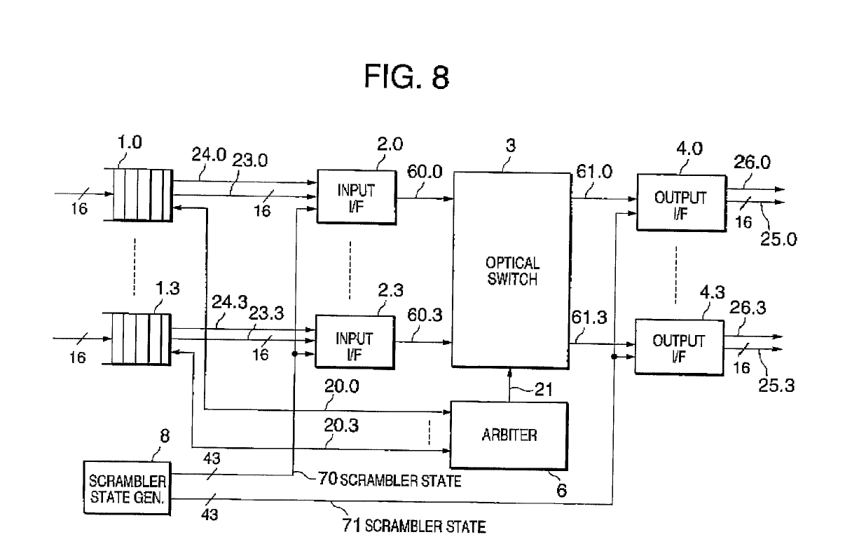

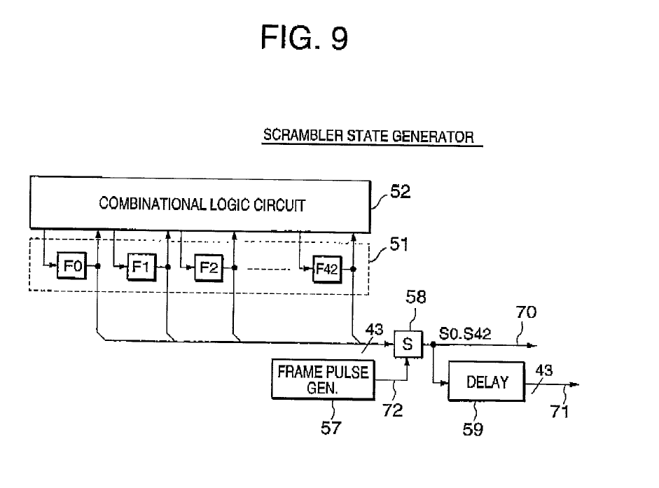

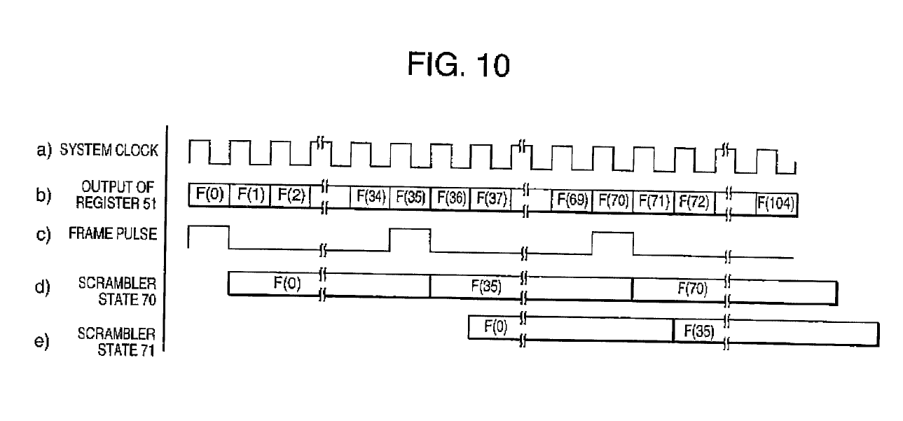

FIG. 8 shows a packet switching system according to the second embodiment. This structure is the same as that of the first embodiment except that a scrambler state generator 8 and scrambler state lines 70 and 71 are provided instead of the reset circuit 7 and the reset lines 22 and 27. FIG. 9 shows the scrambler state generator 8, and FIG. 10 shows an operation of the scrambler state generator 8.

As shown in FIG. 9, the scrambler state generator 8 is composed of a register 51, a combinational logic circuit 52, a frame pulse generator 57, a register 58 and a delay circuit 59.

A system clock is distributed to the scrambler state generator 8, and thereby the register 51, the register 58 and the frame pulse generator 57 operate synchronously with the system clock. The structures and operations of the register 51 and the combinational logic circuit 52 are the same as those of the register 51 and the combinational logic circuit 52 of the scrambler 31 in the first embodiment. Namely, in the register 51, the pseudo-random pattern which is the same as that to be used in the scrambler 31 and the descrambler 45 is generated. The frame pulse generator 57 generates a frame pulse whose cycle is the same as 35 system clock cycles and supplies this frame pulse to the register 58.

The register 58 captures an output of the register 51 when the frame pulse is “1”, and holds a previous value when the frame pulse is “0”. As a result, contents of the register 51 are output per frame cycle to the scrambler state line 70. Moreover, an output of the register 58 is delayed by 37 system clock cycles by means of the delay circuit 59. This delay amount is substantially equal to a delay time of data propagating from the scrambler 31 of the input interface 2 to the descrambler 45 of the output interface 4 (37 system clock cycles). Therefore, a signal, which is delayed from a signal of the scrambler state line 70 by 37 system clock cycles, is output to the scrambler state line 71. Hereinafter, the signals on the scrambler state lines 70 and 71 are called scrambler states.

Input Interface

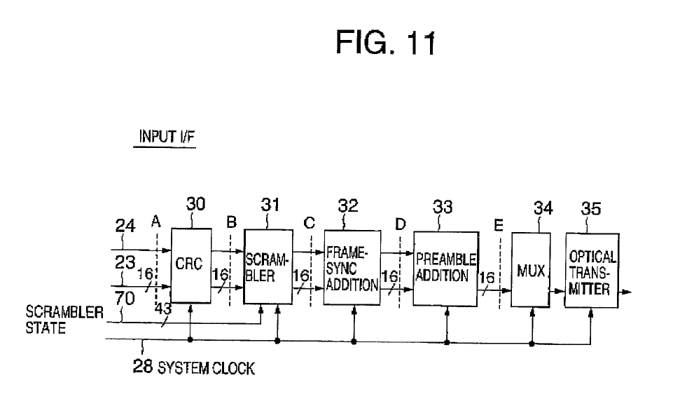

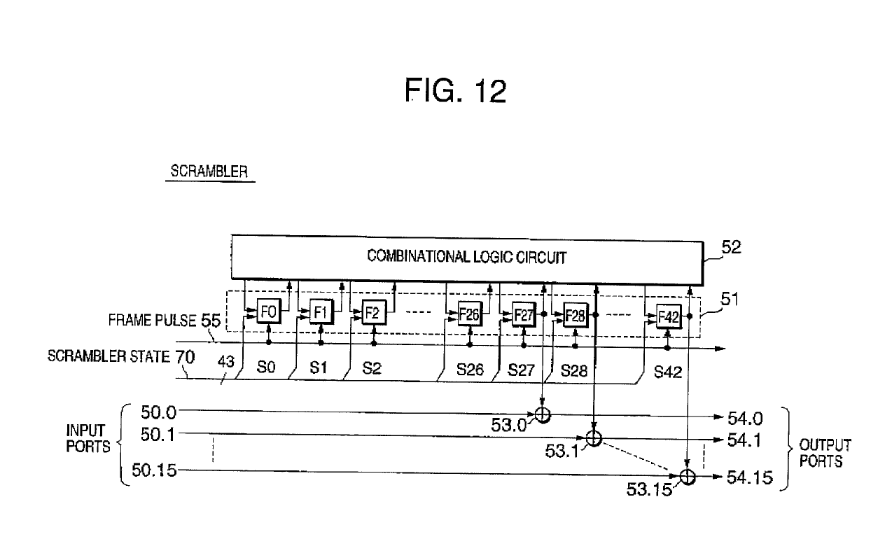

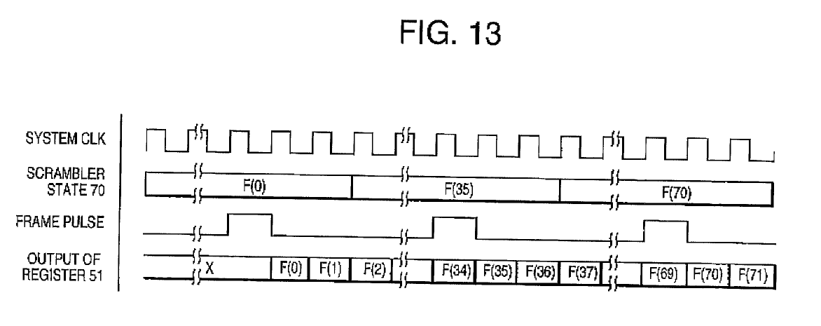

FIG. 11 shows the circuit configuration of the input interface 2. The structure and operation of the input interface 2 in the second embodiment are the same as the operation and structure of the input interface 2 in the first embodiment except that the structure of the scrambler 31 is different and the reset line 22 is replaced with the scrambler state line 70. FIG. 12 shows the scrambler 31, and FIG. 13 shows an operation of the scrambler 31.

The structure of the combinational logic circuit 52 is the same as that in the first embodiment. For this reason, a pseudo-random pattern generated by the scrambler 31 of the second embodiment is equal to that of the scrambler 31 in the first embodiment.

In the scrambler 31 of the second embodiment, the scrambler state line 70 is connected to the register 51, and when a frame pulse input via the frame pulse 55 is “1”, a scrambler state is stored Into the register 51. As a result, the scrambler 31 operates synchronously with the scrambler state generator 8. The scramblers 31 of the all the input interfaces 2 (2.0 through 2.3) operate synchronously with the scrambler state generator 8 so that all the scramblers of the input interfaces 2 also synchronize with each other. Even if the scrambler 31 and the scrambler state generator 8 go out of synchronization due to some cause, when the frame pulse becomes “1” next time, the synchronization is restored.

Output Interface

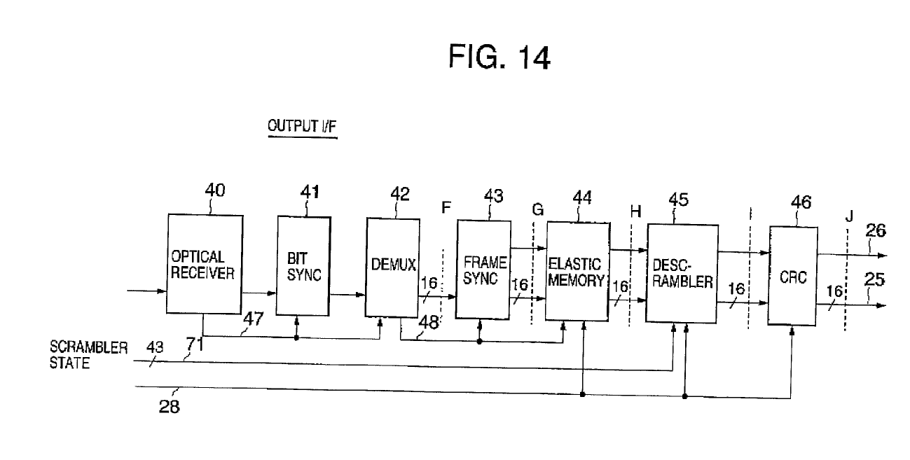

FIG. 14 shows the output interface 4. The structure and operation of the output interface in the second embodiment are the same as the structure and operation of the output interface 4 in the first embodiment as shown in FIG. 6 except that the structure of the descrambler 45 is different and the reset line 27 is replaced with the scrambler state line 71.

Descrambler

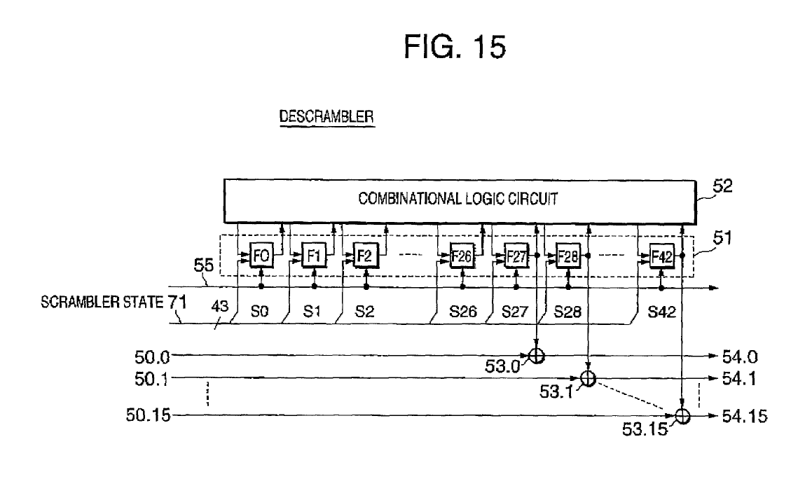

FIG. 15 shows the descrambler 45. The basic structure of the descrambler 45 is the same as that of the scrambler 31 except that the scrambler state line 70 of the scrambler 31 is replaced with the scrambler state line 71. Also the descrambler 45 operates synchronously with the scrambler state generator 8.

The scrambler state on the scrambler state line 71 is delayed from the scrambler state of the scrambler state line 70 by 37 system clock cycles. Since a frame pulse input into the descrambler 45 is delayed from a frame pulse input into the scrambler 31 by 37 system clock cycles, the operation of the descrambler 45 is none other than the operation which is delayed from the operation of the descrambler 31 by 37 system clock cycles. Here, since a time period of 37 system clock cycles is a delay amount of data propagating from the scrambler 31 of the input interface 2 to the descrambler 45 of the output interface 4, in the case where a frame is sent from a certain input interface 2 to a certain output interface 4, the operation of the scrambler 31 is equal to the operation of the descrambler 45 for the frame. Namely, as a result that the descrambler 45 operates synchronously with the scrambler state generator 8, synchronization between the descrambler 45 and the scrambler 31 is also established. Even if a certain descrambler 45 and the scrambler state generator 8 goes out of synchronization due to some cause, when a frame pulse becomes “1” next time, the synchronization state is restored.

In such a manner, according to the second embodiment, all the scramblers 31 of the input interfaces can synchronize with all the descramblers 45 of the output interfaces. Similarly to the first embodiment, since the scramblers 31 and the desscramblers 45 are of frame synchronizing type, even if switching is performed per frame, the synchronization between the scrambler 31 and the descrambler 45 can be maintained.

In the first embodiment, in the case where synchronization of the scramblers 31 or the descramblers 45 is lost due to some reason, it is necessary to reset all the scramblers 31 and the descramblers 45 after loss of synchronization is detected by any method. For this reason, it may take a long time that the synchronizing state is restored. In another means in this case, the scramblers 31 and the descramblers 45 are reset in a certain cycle so that the synchronization state can be automatically restored. However, in order to shorten time required for synchronization restoration, the cycle for resetting should be shortened. This makes no sense in lengthening pattern cycle to be used for scramble.

On the contrary, according to the second embodiment, even if the scrambler 31 and the descrambler 45 are allowed to read scrambler states so as to be re-synchronized with each other, this does not influence on operations of other synchronizing scramblers 31 and descramblers 45 at all. Only scrambler 31 or descrambler 45 which are out of synchronization automatically returns to the synchronizing state. Therefore, even if scrambler and descrambler are re-synchronized with each other in short cycles, proof against attack by a third party in malice is not deteriorated. Namely, the second embodiment has an advantage that, when synchronization between scramblers and descramblers is lost, the time required for sync restoration becomes short.

In the second embodiment, when the scramblers 31 and the descramblers 45 read scrambler states per frame, the synchronization state can be restored at a frame next to the frame at which synchronization is lost. When a cycle that the scrambler 31 and the descrambler 45 read scrambler states is further shortened, time required for returning to the synchronizing state can be shortened further.

In the second embodiment, the scramblers 31 and the descramblers 45 read scrambler states per frame, but the cycle that scramble stat is read is not limited to a frame but can be selected arbitrarily.

### THIRD EMBODIMENT

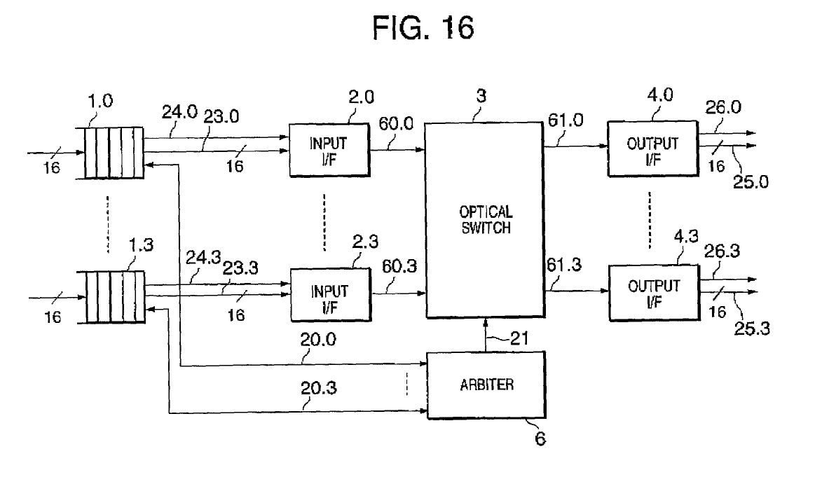

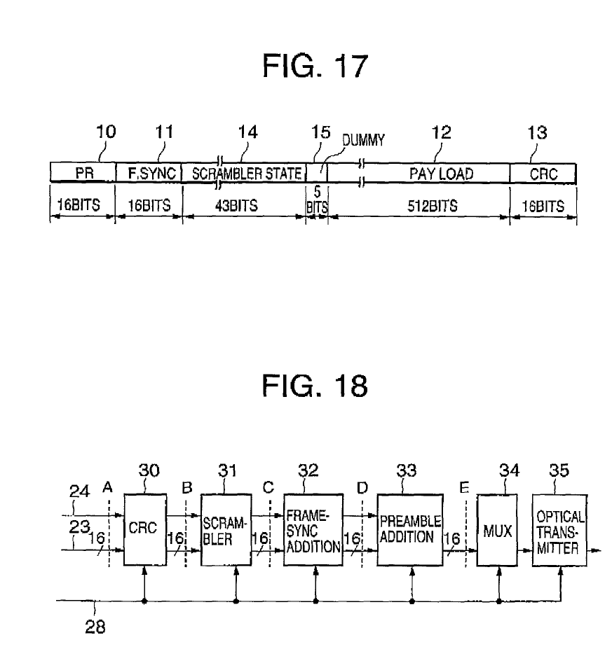

FIG. 16 shows a third embodiment of the present invention. FIG. 17 shows the frame structure in the third embodiment. The third embodiment is also a 4×4 optical packet switching system similarly to the second embodiment, but it is different from the first and second embodiments In that the reset circuit 7 and the scrambler state generator 8 are not provided. Moreover, the frame structure is different from those in the first and second embodiments in that a 43-bit scrambler state 14 of and a 5-bit dummy pattern 15 are added.

A system clock is supplied from a clock source (not shown) to the buffer memories 1, the input interfaces 2, the output interfaces 4, and the arbiter 6. Electrical packet signals inputting into the optical packet switching system are held in corresponding ones of the buffer memories 1 (1.0 through 1.3). The respective buffer memories 1.0 through 1.3 transmit forwarding destinations of the packets to the arbiter 6 via the arbitration lines 20 (20.0 through 20.3). When the forwarding destinations conflict, they are arbitrated by the arbiter 6. As a result of the arbitration, the determined transmission timings of the packets are sent back to respective ones of the buffer memories 1 via the arbitration lines 20. The respective packets output from the buffer memories 1 are stored in the payloads 12 of frames in the input interfaces 2 (2.0 through 2.3) and are converted into optical signals to be sent to the optical switch 3 via optical fibers 60 (60.0 through 60.3).

The optical switch 3 is a 4×4 optical crossbar switch, which switches respective frames under control of the arbiter 6. Switching of the optical switch 3 is performed within the time that the preamble 10 of a frame passes through the optical switch 3. Optical signals output from the optical switch 3 are input into respective ones of the output interfaces 4 (4.0 through 4.3) via the optical fibers 61 (61.0 through 61.3) . The output interfaces 4 convert the received optical signals into electric signals and take the original packets out of the frames.

Input Interface

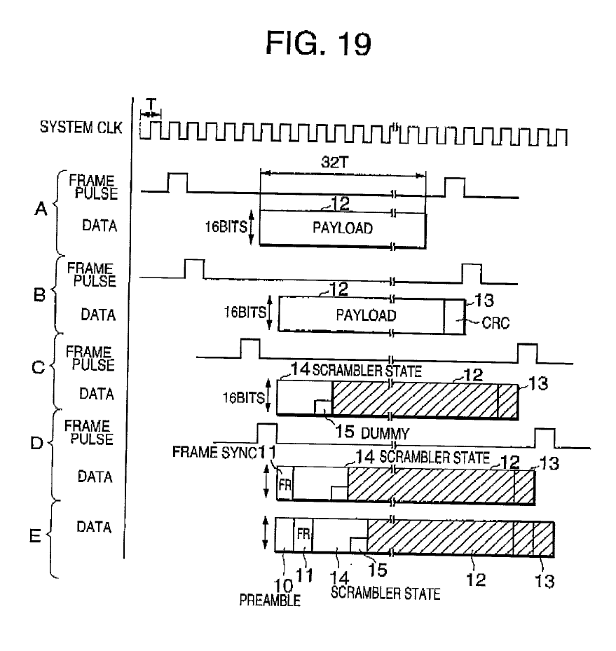

FIG. 18 shows the input interface 2. FIG. 19 shows an operation of the input interface 2. In FIG. 19, A, B, C, D and E represent combinations of data and frame pulse in A, B, C, D and F of FIG. 18, respectively. All blocks from an error detection section 30 to the optical transmitter 35 of the input interface 2 operate in synchronization with a system clock of 150 MHz distributed via the clock line 28. Since the data line 23 is of 16 bit parallel, a time period of 32 system clock cycles is needed to input a packet of 64 bytes into the input interface 2. All 0s are inserted into gaps between the packets. A packet directly becomes the payload 12 of a frame. In parallel with a packet, a frame pulse propagates through the frame pulse line 24. A frame pulse becomes “1” five system clock cycles before the head of the payload 12, and becomes “0” in the other cycles. In the CRC addition section 30, a cyclic redundancy check code of 16 bit is calculated for the payload 12 using a generator polynomial 1+X⁵+X¹²+X¹⁶, and this code is added as CRC 13 to the end of the payload 12.

In the scrambler 31, the payload 12 and CRC 13 are scrambled, and the scrambler state 14 and dummy pattern 15 are added to the head of the payload 12. Shaded portions of C, D and E in FIG. 19 are scrambled portions. In the frame synchronization pattern addition section 32 and the preamble addition section 33, the frame synchronization pattern 11 and preamble 10 are added to the heads of the scrambler states 14, so that a frame is completed. Framed data of 16 bit parallel output from the preamble addition section 33 is converted from parallel to serial by the multiplexer 34 to produce a serial electric signal with bit rate of 2.4 Gb/s. This serial electric signal is converted into an optical signal of 2.4 Gb/S by the optical transmitter 35 and is sent from the input interface 2 to the optical switch 3.

Scrambler

There will be detailed below the operation of the scrambler 31 In the third embodiment.

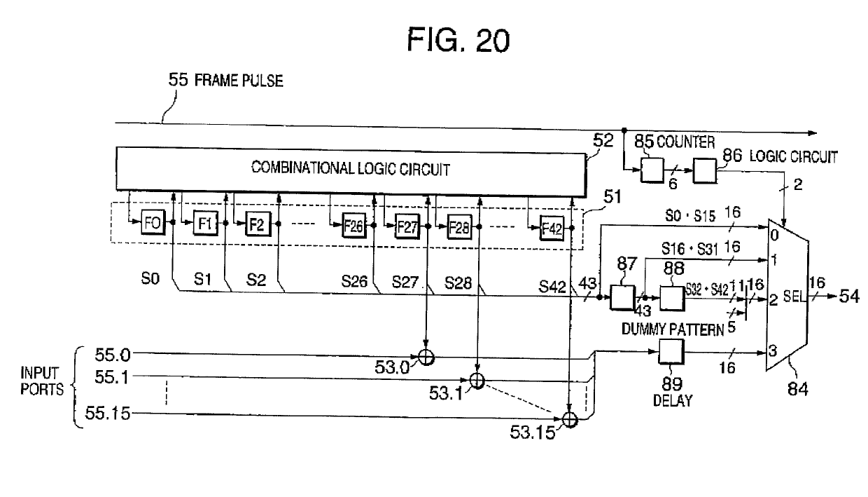

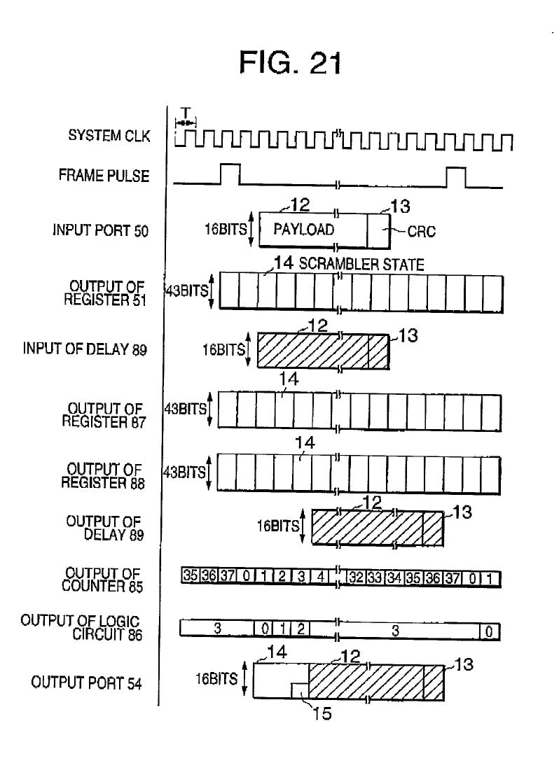

FIG. 20 shows the scrambler 31, and FIG. 21 shows the operation thereof. The scrambler 31 of the third embodiment is constituted so that a circuit for adding a scrambler state 14 and a dummy pattern 15 is added to the scrambler of the first embodiment. The structures and the operations of the register 51, the combinational logic circuit 52 and the XOR circuits 53 are the same as those of the scrambler in the first embodiment.

In the scrambler 31 of the third embodiment, an output of the register 51 is input into a register 87, and an output of the register 87 is input into a register 88. Here, the content of the register 51 at the head of the payload 12 is defined as the scrambler state 14, and the least significant bit (LSB) of the scrambler state 14 is S0, and the most significant bit (MSB) is S42. The bits S0 through S15 of this scrambler state 14 are input directly into a 0-th input port of a selector 84. The bits S16 through S31 are delayed by 1 system clock cycle by means of the register 87 to be input into a first input port of the selector 84. The bits S32 through S42 are delayed further by 1 system clock cycle by means of the register 88 to be input into a second input port of the selector 84. Data which are delayed by 3 system clock cycles by means of the delay circuit 89 are input into a third input port of the selector 84.

Since the selector 84 is a 4×1 selector of 16 bit parallel, a dummy pattern 15 is input into a 5-bit residual portion generated at the second input port. In the third embodiment, all the dummy patterns 15 are 0s. A counter 85 is reset by a frame pulse and increments in synchronization with the system clock A logic circuit 86 is a circuit for outputting a control signal of the selector 84. When an output of the counter 85 is 1, 2 or 3, the logic circuit 86 outputs 0, 1 or 2, and outputs 3 when the output of the counter 85 is other than 1, 2 or 3. When a selector control signal is 0, 1, 2 or 3, the selector 84 outputs the signal input into the 0-th input port, the first input port, the second input port or the third input port, respectively.

According to the above structure, data output from the output port 54 of the scrambler 31 has the scrambler state 14 and dummy pattern 15 added to the scrambled payload 12 and CRC 13.

Output Interface

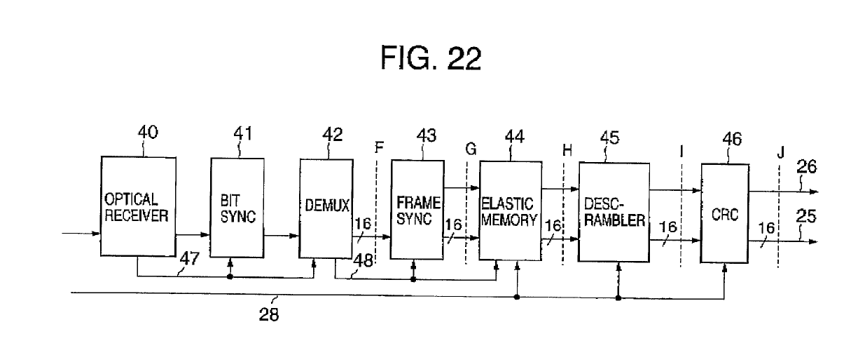

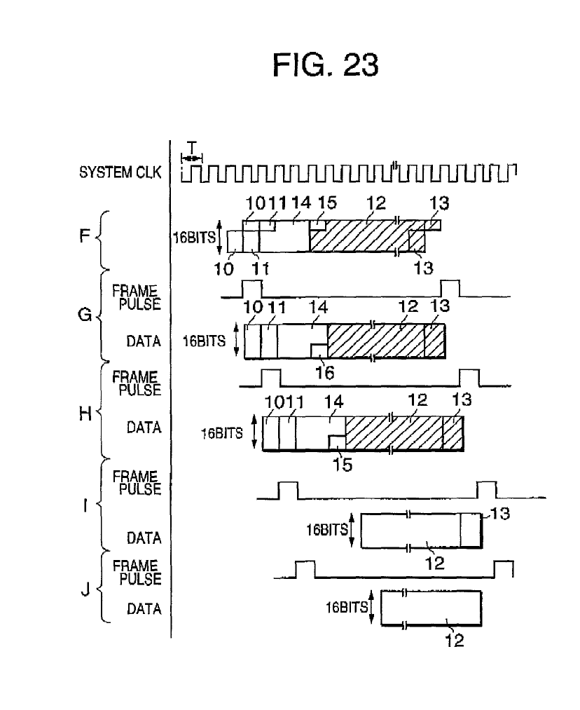

There will be explained below the structure and operation of the output interface 4 in the third embodiment. FIG. 22 shows the output interface 4, and FIG. 23 shows the operation thereof. F, G, H, I and J in FIG. 23 represent data and frame pulse in F, G, H, I and J of FIG. 22, respectively. Since the structures and operations of the optical receiver 40, the bit sync section 41, the demultiplexer 42, the frame sync section 43 and the elalstic memory 44 in the third embodiment are the same as those in the first embodiment, the description thereof will be omitted.

Descrambler

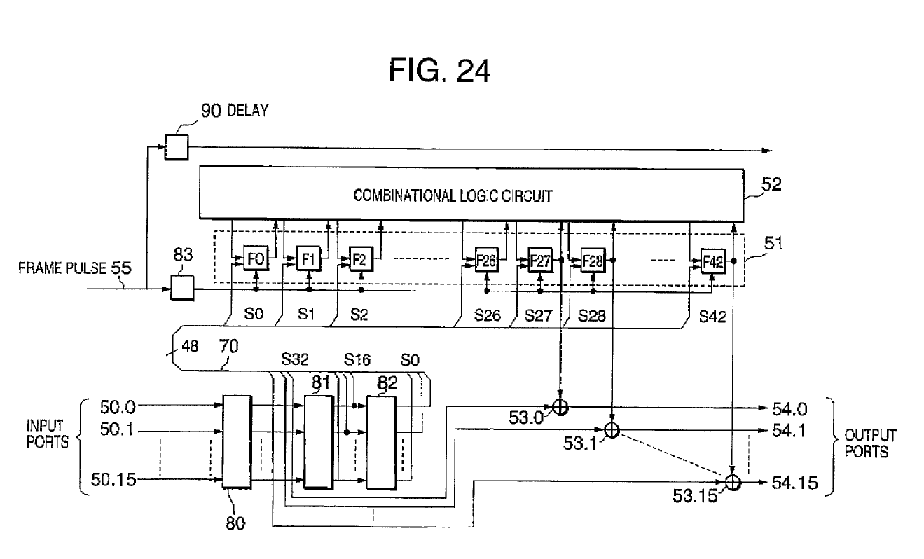

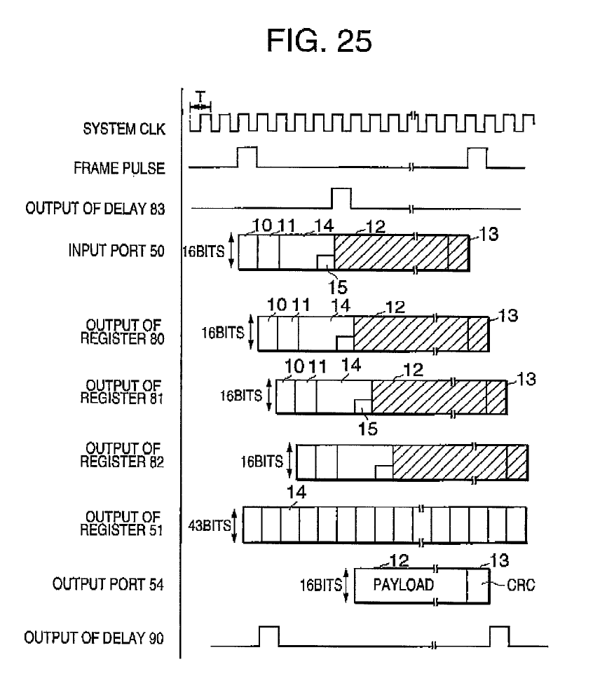

FIG. 24 shows the descrambler 45, and FIG. 25 shows the operation of the descrambler 45. The structures and operations to the register 51 and the logic circuit 52 of the descrambler 45 in the third embodiment are the same as those of the descramblers 45 in the first and second embodiments. The third embodiment is different from the first and second embodiments in that a circuit for capturing the scrambler state 14 contained in a frame into the register 51 is provided.

Data input from input ports 50 (50.0 through 50.15) are stored first in a register 80. The data are delayed by 1 system clock cycle and then are stored in a register 81. Next, the data are delayed further by 1 system clock cycle and then are stored in a register 82.

Meanwhile, a frame pulse input by the frame pulse line 55 is delayed by 5 system clock cycles by a delay circuit 83. When an output of the delay circuit 83 is “1” the bits S0 through S15 of the scrambler state 14 are captured into the register 51 through the register 82, the bits S16 through S31 are captured into the register 51 through the register 81, and the bits S32 through S42 are captured into the register 51 through the register 80. These are used as initial values, the payload 12 and CRC 13 are descrambled by the output of the register 51. Actually, the preamble 10, frame synchronization pattern 11, scrambler state 14 and dummy pattern 15 are scrambled in the descrambler 45. However, since these fields are not necessary for processes hereinafter, they are omitted in FIG. 25. The frame pulse is delayed by 1 system clock cycle by means of a delay circuit 90.

The data and the frame pulse output from the descrambler 45 are input into the error detection section 46. The error detection section 46 detects an error as the case of the first and second embodiments, and simultaneously sets all the preamble 10, frame synchronization pattern 11, scrambler state 14, dummy pattern 15 and CRC 13 to “0”, and directly outputs only the payload 12, namely, the packet.

In the optical packet switching system according to the third embodiment, packets are switched in the above manner. In the third embodiment, a frame for storing a packet therein is scrambled by using a pseudo-random pattern with sufficiently long cycle of (243−1) bit, and the scramblers 31 and the descramblers 45 are not reset per frame and operate continuously. Therefore, even if a pseudo-random pattern which is the same one used for the scrambler 31 is sent by a third party, there is a very weak possibility of 1/(243−1) that this pattern synchronizes with the scrambler 31 and the same codes are generated continuously.

In the third embodiment, in the scrambler 31 of the input interface 2, a value of the register 51 at the head of the payload 12 is added as the scrambler state 14 to a frame. In the descrambler 45 of the output interface 4, the scrambler state 14 which is added to the frame is used as an initial value so that the payload 12 and CRC 13 are descrambled. As a result, even if switching is performed by the optical switch 3 per frame, a scrambler of an input interface into which a certain frame is transmitted synchronizes with a descrambler of an output interface which receives the frame.

In the third embodiment, the descramblers 45 of the output interfaces 4 (4.0 through 4.3) synchronize with the scramblers 31 of the input interfaces independently. For this reason, even if a certain descrambler 45 does not synchronize with a scrambler 31, their synchronizing state can be restored without influencing operations of other scramblers 31 and descramblers 45.

In addition, since each of the descramblers 45 restores synchronization for each frame, even if they do not synchronize with the scramblers while receiving a certain frame, the synchronizing state can be restored at next frame.

In addition, the third embodiment adopts the frame synchronizing scramble, but the same effect can be obtained by employing a self-synchronizing scramble.

In the above-mentioned embodiments, the present invention is applied to an optical packet switching system, but the present invention is applicable also to an electric packet switching system. Moreover, the present invention is not limited to a packet switching system in which a packet is stored in a payload of a frame, and the present invention is applicable also to a switching system in which a payload of a frame is not a packet.

In addition, in the present invention, the number of input ports and output ports of the optical switch, a frame structure, clock frequency and the like are not limited to those in the respective embodiments, and they can be determined arbitrarily.

Further, the buffer system of the switching system of the present invention is not limited to input buffer-type packet switching system, and it may be an output buffer type, for example, or an optical buffer memory can be used.

In addition, the present invention can be applied also to a bit sync system other than a multiphase-clock bit sync system. For example, a PLL circuit, a tank circuit or the like can be used, and a serial clock is distributed or the length of a signal path is adjusted so that the bit synchronization can be realized.

In addition, in the present invention, the elastic memory 44, the CRC addition section 30 and the error detection circuit 46 are not exactly required. Further, in the present invention, a generator polynomial for generating a pattern to be used for scramble can be selected arbitrarily.

As described above, a scramble method of the switching system according to the present Invention has an advantage such that all scramblers and descramblers are reset simultaneously and thereby the scramblers can synchronize with the descramblers without resetting them for each frame.

In addition, a cycle of a pattern to be used for scramble is set to be longer than a length of a frame and the scramblers and descramblers are not reset per frame. This can prevent mixing an obstructive pattern where the same codes are generated continuously in synchronization with the scramblers.

The scramblers and descramblers read a scrambler state per frame, and thereby the synchronization state can be restored at a frame next to the frame where the synchronization is lost. A cycle that the scramblers and descramblers read a scrambler state is further shortened so that the time required for restoring synchronization can be shortened further.

In addition, the input interface adds a scrambler state signal representing an internal state of a scrambler to a frame and transmits the signal to the switch. The output interface receives the signal from the switch and the scrambler state signal is captured by the descrambler. As a result, in the case where a certain scrambler or descrambler does not synchronize with other scramblers or descramblers, the synchronizing state can be restored without influencing operations of other scramblers or descramblers at all. Therefore, since scramblers or descramblers can frequently re-synchronize with each other, the time from loss of synchronization to restoration can be shortened.

1. In a switching system comprising:
a switch;
a plurality of input interfaces each connected to input ports of the switch, each of the input interfaces including a scrambler using a predetermined pseudorandom pattern generator, wherein each of the input interfaces inputs data to sequentially output frames including scrambled data to a corresponding input port of the switch; and
a plurality of output interfaces each connected to output ports of the switch, each of the output interfaces including a descrambler using the predetermined pseudorandom pattern generator, wherein each of the output interfaces inputs frames including scrambled data from a corresponding output port of the switch to output frames of original data,
a scramble control method comprising the steps of:
resetting the scramblers simultaneously; and
resetting the descramblers simultaneously.

2. The scramble control method according to claim 1, wherein the scramblers and the descramblers operate according to a predetermined system cloak, wherein
the scramblers are simultaneously initialized at a first time point and thereafter are not reset, and
the descramblers are simultaneously initialized at a second time point and thereafter are not reset, wherein the second time point is delayed from the first time point by a time period required for transferring a frame from an input interface to an appropriate output interface through the switch.

3. The scramble control method according to claim 2, wherein the first time point is a time when the switching system starts up.

4. The scramble control method according to claim 1, wherein the scramblers and descramblers are of frame synchronizing type.

5. The scramble control method according to claim 4, wherein a cycle of a pseudorandom pattern generated by the predetermined pseudorandom pattern generator is set to be longer than a length of the frame.

6. The scramble control method according to claim 5, wherein the predetermined pseudorandom pattern generator uses a generator polynomial. 130 X⁴³.

7. The scramble control method according to claim 1, further comprising the steps of:
generating a scrambler state indicating a pseudorandom pattern generated by the predetermined pseudorandom pattern generator at predetermined intervals;
sending the scrambler state to the scramblers so that the scramblers are simultaneously reset to the pseudorandom pattern indicated by the scrambler state; and
sending the scrambler state to the descramblers with a delay of a time period required for transferring a frame from an input interface to an appropriate output interface through the switch, so that the descramblers are simultaneously reset to the pseudorandom pattern indicated by the scrambler state.

8. The scramble control method according to claim 7, wherein the scramblers and descramblers are of frame synchronizing type.

9. The scramble control method according to claim 7, wherein a cycle of a pseudorandom pattern generated by the predetermined pseudorandom pattern generator is set to be longer than a length of the frame.

10. The scramble control method according to claim 9, wherein the predetermined pseudorandom pattern generator uses a generator polynomial: 1+X⁴³.

11. In a switching system comprising:
a switch;
a plurality of input interfaces each connected to input ports of the switch, each of the input interfaces including a scrambler using a predetermined pseudo random pattern generator wherein each of the input interfaces inputs data to sequentially output frames including scrambled data to a corresponding input port of the switch; and
a plurality of output interfaces each connected to output ports of the switch, each of the output interfaces including a descrambler using the predetermined pseudorandom pattern generator, wherein each of the output interfaces inputs frames including scrambled data from a corresponding output port of the switch to output frames of original data,
a scramble control method comprising the steps of:
at each of the scramblers,
generating a scrambler state indicating a pseudorandom pattern generated by the predetermined pseudorandom pattern generator in frame timing;
assembling a frame Including the scrambler state;
transferring the frame including the scrambler state to the switch;
at each of the descramblers,
receiving a frame including a scrambler state;
resetting the predetermined pseudorandom pattern generator to the pseudorandom pattern indicated by the scrambler state.

12. The scramble control method according to claim 11, wherein the scramblers and descramblers are of self-synchronizing type.

13. The scramble control method according to claim 11, wherein the scramblers and descramblers are of frame synchronizing type.

14. The scramble control method according to claim 11, wherein a cycle of a pseudorandom pattern generated by the predetermined pseudorandom pattern generator is set to be longer than a length of the frame.

15. The scramble control method according to claim 14, wherein the predetermined pseudorandom pattern generator uses a generator polynomial: 1+X⁴³.

16. A switching system comprising:
a switch;
a plurality of input interfaces each connected to input ports of the switch, each of the input interfaces including a scrambler using a predetermined pseudorandom pattern generator, wherein each of the input interfaces inputs data to sequentially output frames including scrambled data to a corresponding input port of the switch;
a plurality of output interfaces each connected to output ports of the switch, each of the output interfaces including a descrambler using the predetermined pseudorandom pattern generator, wherein each of the output interfaces inputs frames including scrambled data from a corresponding output port of the switch to output frames of original data; and
a reset pulse generator for generating a scrambler reset pulse and a descrambler reset pulse, wherein the scrambler reset pulse is sent to all the scramblers at equal timing, and the descrambler reset pulse is sent to all the descramblers at equal timing.

17. The switching system according to claim 16, wherein the scramblers and the descramblers operate according to a predetermined system clock, wherein
the scramblers are initialized in response to the scrambler reset pulse and thereafter are not reset, and
the descramblers are initialized in response to the descrambler reset pulse and thereafter are not reset, wherein the descrambler reset pulse is delayed from the scrambler reset pulse by a time period required for transferring a frame from an input interface to an appropriate output interface through the switch.

18. A switching system comprising:
a switch;
a plurality of input interfaces each connected to input ports of the switch, each of the input interfaces including a scrambler using a predetermined pseudorandom pattern generator, wherein each of the input interfaces inputs data to sequentially output frames including scrambled data to a corresponding input port of the switch;
a plurality of output interfaces each connected to output ports of the switch, each of the output interfaces including a descrambler using the predetermined pseudorandom pattern generator, wherein each of the output interfaces inputs frames including scrambled data from a corresponding output port of the switch to output frames of original data; and
a scramble state generator for generating a scrambler state indicating a pseudorandom pattern generated by the predetermined pseudorandom pattern generator at predetermined intervals, wherein
the scrambler state is sent to the scramblers so that the scramblers are simultaneously reset to the pseudorandom pattern indicated by the scrambler state, and
the scrambler state is sent to the descramblers with a delay of a time period required for transferring a frame from an input interface to an appropriate output interface through the switch, so that the descramblers are simultaneously reset to the pseudorandom pattern indicated by the scrambler state.

19. A switching system comprising:
a switch;
a plurality of input interfaces each connected to input ports of the switch, each of the input interfaces including a scrambler using a predetermined pseudorandom pattern generator, wherein each of the input interfaces inputs data to sequentially output frames including scrambled data to a corresponding input port of the switch; and
a plurality of output interfaces each connected to output ports of the switch, each of the output interfaces including a descrambler using the predetermined pseudorandom pattern generator, wherein each of the output interfaces inputs frames including scrambled data from a corresponding output port of the switch to output frames of original data,
wherein each of the scramblers further comprises:
a scramble state generator for generating a scrambler state indicating a pseudorandom pattern generated by the predetermined pseudorandom pattern generator in frame timing; and
an assembler for assembling a frame including the scrambler state, and
each of the descramblers further comprises:
a reset circuit for resetting the predetermined pseudorandom pattern generator to the pseudorandom pattern indicated by a scrambler state included in a frame received from the switch.
